(19) United States
(12) Patent Application Publication
(10) Pub. No.: US 2006/0169194 A1
(43) Pub. Date: Aug. 3, 2006

(54) Warning device for vehicles involved in an accident and improvements introduced in the device for warning of broken-down vehicles

(76) Inventor: Joaquin Zumaquero Jimenez, Santa Margarida de Montbui (ES)

Correspondence Address: WILLIAM COLLARD;COLLARD & ROE, P.C., 1077 NORTHERN BOULEVARD, ROSLYN, NY, 11576, US

(21) Appl. No.: 11/341,974

(22) Filed: Jan. 27, 2006

(30) Foreign Application Priority Data
Jan. 28, 2005 (ES) U200500161(9)
Dec. 23, 2005 (ES) U200503174(7)

(51) Int. Cl. B60Q 7/00

(52) U.S. Cl. 116/35 R

(57) ABSTRACT

A warning device for vehicles involved in an accident consists of one or more ejectable and instantly inflatable marker balloons with an inert gas that is lighter than air, which are deployed deflated and folded in holders distributed throughout the vehicle. The marker balloons have devices for automatic injection and inflation, connected to impact sensors throughout the vehicle, such that the balloons are ejected and inflated instantaneously in the event that one of the sensors detects a collision or impact.

### OBJECT OF THE INVENTION

The present invention relates to a warning device for vehicles involved in an accident and improvements made to the warning device for broken-down vehicles.

### BACKGROUND OF THE INVENTION

Currently, vehicles have a hazard warning light, consisting of simultaneous flashing of both indicators, in order to warn other drivers, for example, in the event of sudden breaking because of a traffic jam.

This warning, however, requires a voluntary and conscious action on the part of the driver to switch it on, and in the event of an accident involving loss of consciousness or sudden feinting of the driver, it cannot be activated, and therefore other drivers cannot be warned for example, of an accident on the road, with the corresponding danger or fright, or if a vehicle involved in an accident leaves the road, the warning cannot cooperate in the detection of the accident, which might be an essential factor for attending, or even saving the life of an injured person.

There is also the possibility of an incident with the vehicle, for example, a mechanical failure, which can be indicated by the four indicators of the vehicle but which, especially during strong daylight, are not very visible for other road users.

These drawbacks are overcome with the installation of the device of the invention in the vehicles.

### DESCRIPTION OF THE INVENTION

The device of the invention has an optimal constitution and automatic operation, that facilitates warning and perception by other drivers in the event of a an accident with the vehicle, decreasing the danger for third parties and facilitating the localization of the vehicle in the event that it has come off the road.

In accordance with the invention, the device consists of one or more ejectable and instantly inflatable marker balloons with an inert gas that is lighter than air, which are deployed deflated and suitably folded in holders distributed throughout the vehicle, specifically in the chassis and obviously on the outside.

The marker balloons are associated with means for automatic ejection and inflation, connected to impact sensors distributed throughout the vehicle, such that they are ejected and inflated instantaneously in the event that one of these sensors detects a collision or impact.

The marker balloons, once ejected and inflated, remain attached to the vehicle by one or more chords, such that they do not freely escape, and moreover may be stirred by the air improving the perception or drawing the attention of other drivers.

Logically, the marker balloons will be in bright colors, and preferable in reflective yellow color, with the possibility of reflective strips.

According to some improvements to the invention, the incorporation in the holder of a manageable and portable casing is contemplated, of the size of, for example, a flashlight or cigarette lighter, one or more inflatable reflective marker balloons deflated and folding, also incorporating in the casing means for ejection and automatic inflation, manually operated by the user through the corresponding control in the casing.

The casing is of reasonable size to be readily stored in the vehicle, for example, in the glove box, and preferably has ergonomic outer forms that make its handling more comfortable.

In the event of breakdown or accident that is not detected by the impact sensors in the vehicle, the driver may take hold of the device from the glove box and, lowering the window or getting out the vehicle, can activate the control so that the marker balloon or marker balloons are deployed and inflated, warning over vehicles of the incident.

The marker balloon or marker balloons deployed and inflated will remain attached to the portable holder by means of one or more chords.

### BRIEF DESCRIPTION OF THE DRAWINGS

FIGS. 1 and 2 schematically show the device of the invention in its initial position and deployed in the event of an accident.

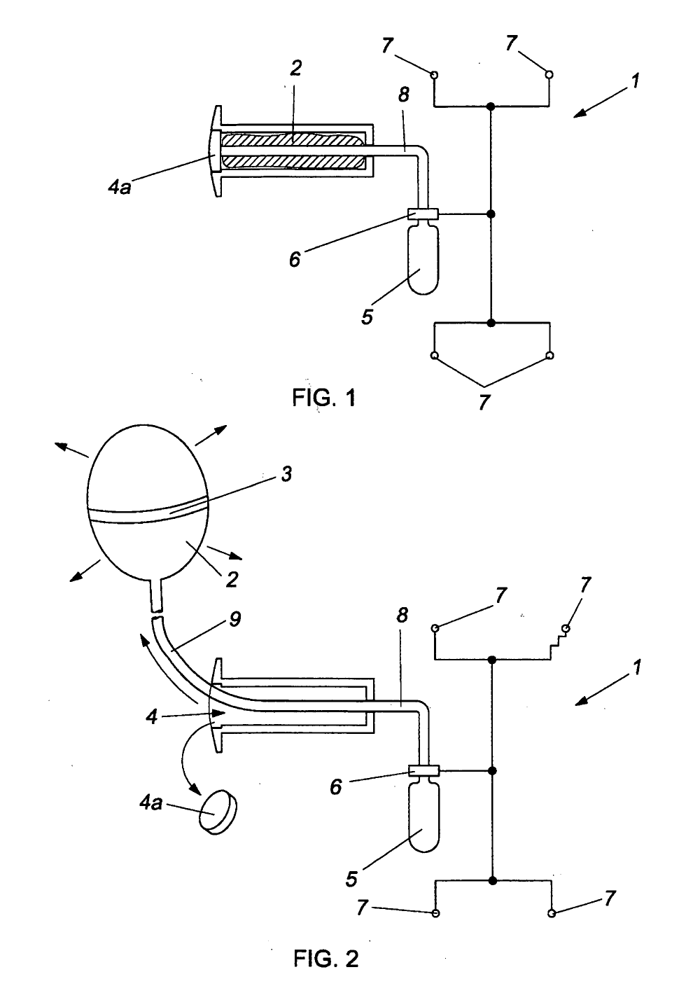

FIGS. 3, 4 and 5 show views of the vehicles involved in an accident and equipped with the device of the invention.

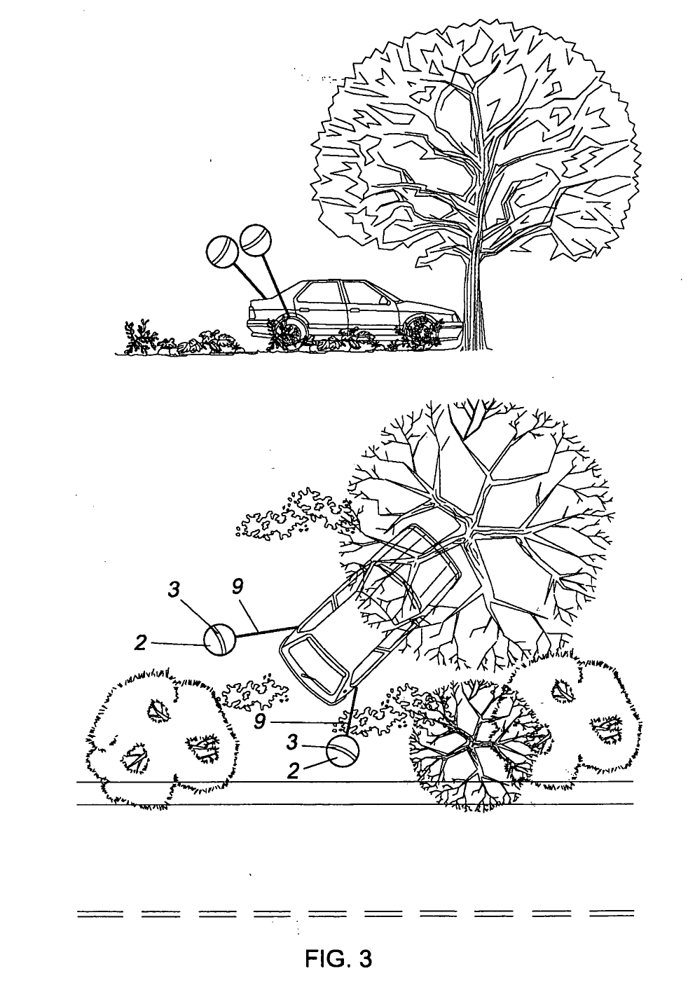

FIG. 6 shows a view of the device according to the improvements of the invention.

FIG. 7 shows a view of the device of FIG. 6 in which the marker balloon appears folded and inside the holder of the portable casing.

FIG. 8 shows a view of the device of the invention of FIG. 6 in which the marker balloon appears deployed.

### DESCRIPTION OF A PRACTICAL EMBODIMENT OF THE INVENTION

The device 1 of the invention comprises one or more instantly ejectable and inflatable marker balloons 2 of a reflective color, which will be preferable approved class 2 yellow according to guidelines EN-471, and with 3 retro-reflective strips.

Each marker balloon is set up deflated, occupying a very small space, in a holder 4 set in the chassis of the vehicle and equipped with a fitted protective cover 4a that comes away under the impulse of the ejection of the marker balloon.

Each marker balloon, individually, or optionally in unison if the vehicle has several marker balloons, is associated with a means for ejection and means for instantaneous inflation, which can be grouped into a single means for ejection and instantaneous inflation. Preferably, these unique means consist of one or more cylinders 5 for storage of an inert gas that is lighter than air at the pressure necessary and sufficient to cause both the ejection and the inflation of the marker balloon, which will have been previously folded in its housing such that the sudden pressure surge of gas will first lead to it being expelled or ejected from the housing and then inflated.

Several means for automatic uncovering 6 of the bottles 5 are available, controlled by impact sensors 7. Preferably, and necessarily if the bottle or bottle are outside the marker balloons, these means for uncovering are connected to filling conducts 8 of the corresponding marker balloons. These conducts 8, once the marker balloon has been ejected and inflated, will remain connected to the vehicle by means of a chord 9, to prevent them from floating upwards and getting lost.

Given that the gas that fills the marker balloon is lighter than air, it will float like a balloon attached to the chassis of the vehicle and will be moved by the air, which will further attract the attention of other drivers. It is estimated that with an appropriate marker balloon size, of about 50 cm diameter, and conducts 8 of a length of 1 to 1.5 meters, it will be visible from 400 meters or more.

With regard to the impact sensors, those of the vehicle associated with the airbags with which the vehicle is equipped may be used, or also some dedicated sensors may be implanted. Similarly, the means for uncovering 6 the bottles holding the gas can be similar to those used in the operation of any airbag, and are not object of the present invention.

As can be seen in the figures, the arrangement considered ideal for the vehicle includes four marker balloons set slightly towards the corners such that, in the event of an accident on either side that may disable some of the marker balloons, others will always be operational.

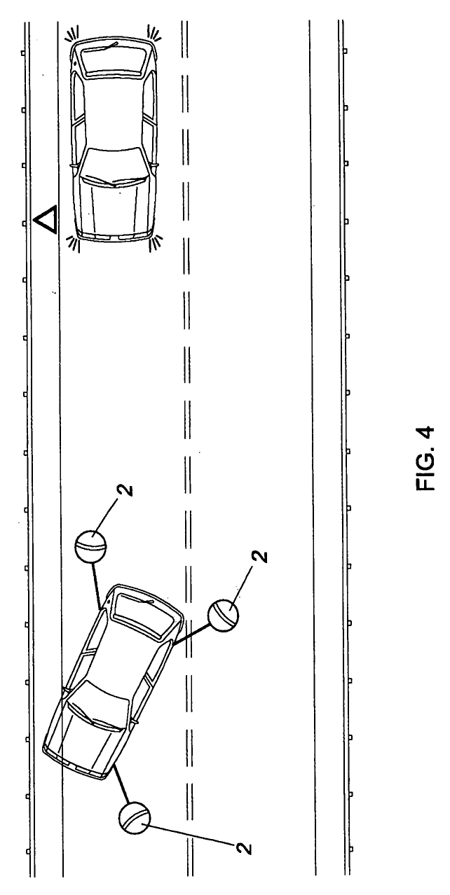

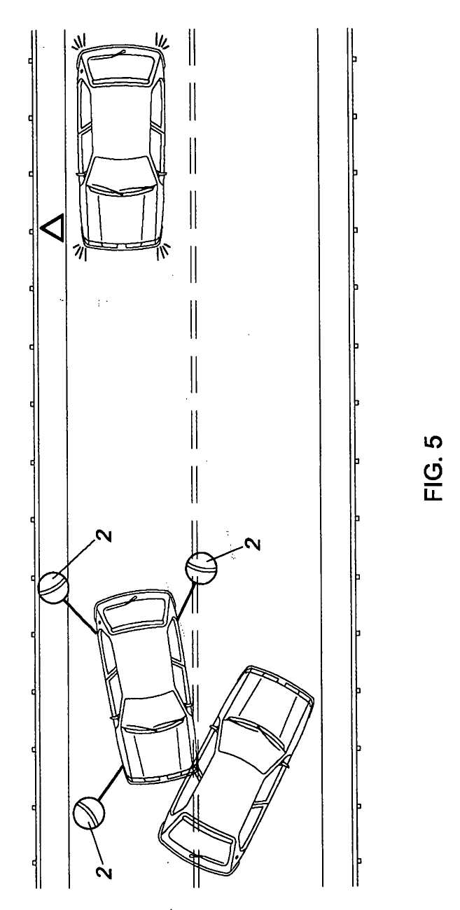

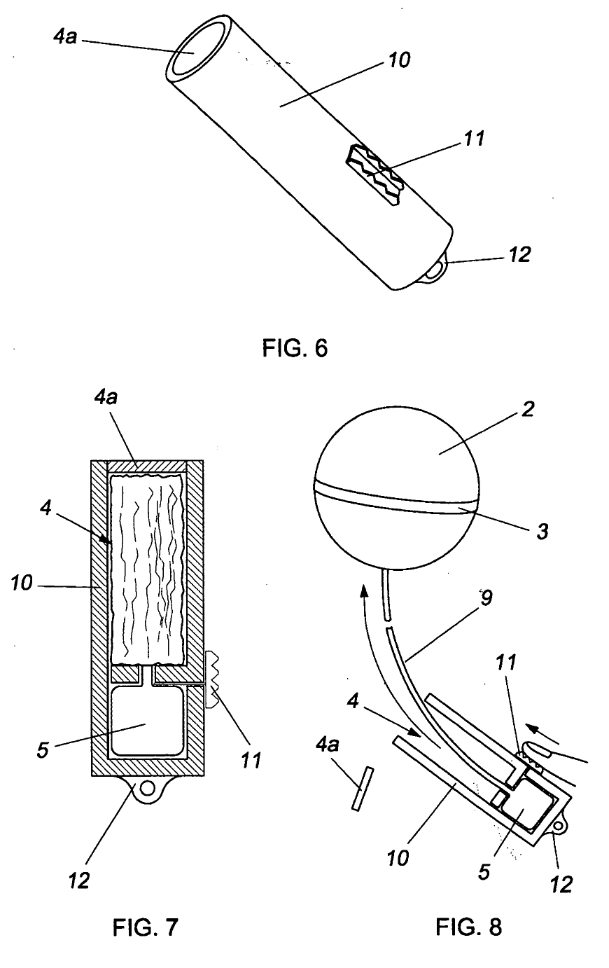

Some improvements to the invention that are shown in FIGS. 6, 7 and 8 comprise implementing a casing 10 independently of the vehicle, which is portable, of a suitable size for, for example, fitting in the glove box of the vehicle, and which incorporates the means for automatic ejection and inflation, for example a bottle 5 of inert gas slightly lighter than air at a suitable pressure and its device for automatic release 6, as well as a housing or holder 4 with a cover 4a where at least one marker balloon 2 is folded.

In the casing 10, a control 11 is also incorporated that is manually activated by which the user or driver can operate the means for ejection and inflation of the marker balloon (for example, operating the automatic release device 6 of the bottle 5), which would lead to the immediate ejection and inflation of the marker balloon with removal of the cover 4a.

In the event of breakdown or a flat tire, the driver or any other occupant of the vehicle may take, for example, the device from the glove box and, lowering the window or getting out of the vehicle, immediately produce the ejection and inflation of the marker balloon 2 manually to warn of the incident, the marker balloon remaining attached to the bottom of the holder 4 by means of a chord 9, which may coincide with the inflation conduct itself. The marker balloon has bright colours and 3 retro-reflective strips, which improves its visibility.

In the casing 10, in addition, it is preferable to implement some means such as clamps 12 that allow it to be attached to the vehicle to prevent the marker balloon or marker balloons from being dragged by the air and lifted up by the effect of the gas that they contain.

With the nature of the invention described in sufficient detail, as well as an embodiment in practice, it should be stated that the arrangement presented above and represented in the drawings attached are susceptible to changes in detail that do not alter the fundamental principle.

1. Warning device for broken down vehicles; characterized in that it comprises one or more ejectable marker and marker balloons instantaneously inflatable with an inert gas lighter than air, which are deployed deflated and suitably folded in holders distributed throughout the vehicle; the marker balloons are associated with means for ejection and instantaneous inflation connected to impact sensors distributed throughout the vehicle; the marker balloons are attached to the vehicle once ejected and inflated by, at least, one chord.

2. Device according to claim 1, characterized in that the marker balloons are of reflective colours and include retro-reflective strips.

3. Device according to claim 1, characterized in that the holders that contain the folded marker balloons are equipped with protective covers that come away when the marker balloons are ejected.

4. Device according to claim 1, characterized in that the means of ejection and inflation are the same.

5. Device according to claim 4, characterized in that the same means of ejection and inflation consist of one or more pressurized gas cylinders at sufficient pressure to cause the ejection and inflation of the marker balloons, which will be preferably folded into their holders such that the surge of gas first causes the ejection and then the inflation.

6. Device according to claim 1, characterized in that the holders incorporate protective covers that come away when the marker balloons are ejected.

7. Device according to claim 1, characterized in that preferably four marker balloons are preferably deployed at the corners.

8. Device according to claim 1, characterized in that the impact sensors are common to other systems of the vehicle.

9. Device according to claim 1, characterized in that the impact sensors are for exclusive use by the device.

10. Improvements introduced in the warning device for broken-down vehicles, characterized in that it comprises incorporating a portable manageable casing, independent of the vehicle, and of a reduced size, a holder for a marker balloon or balloons appropriately folded, some means of automatic ejection and inflation of said marker balloon and some manually operated control for the user able to trigger the ejection and inflation of the marker balloon, which will remain attached to the casing by the corresponding chord.

11. Improvements according to claim 10, characterized in that the holder of the portable casing is equipped with a cover that comes away automatically on ejection of the marker balloon.

12. Improvements according to claim 1, characterized in that the casing is of ergonomic form.

13. Improvements according to claim 1, characterized in that the casing incorporates means for attachment to the vehicle, such as some clamps.
